(19) United States
(12) Patent Application Publication
(10) Pub. No.: US 2017/0188076 A1
(43) Pub. Date: Jun. 29, 2017

(54) Mobile Front-End for a Video Platform Method and System

(71) Applicant: Sqoony B.V., Breda (NL)

(72) Inventors: David GOMMEREN, Breda (NL); Daan BEMELMANS, Breda (NL)

(21) Appl. No.: 15/390,937

(22) Filed: Dec. 27, 2016

Related U.S. Application Data
(60) Provisional application No. 62/387,597, filed on Dec. 28, 2015.
(60) Provisional application No. 62/279,526, filed on Jan. 15, 2016.

(51) Int. Cl. H04N 21/414; H04N 21/45; H04N 21/475; H04N 21/61; H04N 21/462

(52) U.S. Cl. CPC H04N 21/41407; H04N 21/6131; H04N 21/4622; H04N 21/4753; H04N 21/4532

(57) ABSTRACT

A system for efficient, asynchronous video data delivery, comprising a front-end platform, an app, a mobile device for operating said front-end platform and said app, and a video delivery platform, wherein said video delivery platform notifies said front-end platform of availability of a video clip according to a notification message and wherein said front-end platform pulls said video clip from said video delivery platform according to said notification message when said mobile device is connected to a network technology that does not involve cellular telephone network data delivery, and wherein said app has access to said video according to at least one control by said front-end platform. Optionally said network technology comprises WiFi.

### FIELD OF THE INVENTION

The present invention relates, in at least some embodiments, to a system and method for a front end for controlled distribution video clips to mobile devices and in particular, to such a system and method in which obtaining video data by the mobile device is preferably asynchronous with video data display.

### BACKGROUND OF THE INVENTION

Mobile devices are becoming increasingly the computational device of choice for many users. However mobile devices have some drawbacks with regard to downloading and displaying video data: video storage is limited and video providers often want to be able to control the number of times that video playback is possible and/or to prevent unauthorized sharing of video data, so video providers often prefer streaming video. However, mobile service providers, such as cellular telephone companies, often charge excessively for downloading the large amounts of data required to display a video, yet often bandwidth is quite limited. Streaming can therefore be an unpopular choice for obtaining video data, particularly since many mobile device users prefer to obtain data through WiFi, a connection which is often free or at least not metered to the extent that cellular data is.

Various attempts to provide video data in a more efficient manner have been described, but none of them overcome all of the above drawbacks. For example, US Published Application No. 20060277271 to Morse et al describes a system and method for pre-fetching content. Unfortunately this system and method does not provide for adequate control over the video data, such that video data providers would not have sufficient safeguards. US Published Application No. 20140171204 to Cox et al describes a method for asynchronous video delivery as part of playing a game, but once delivered, there are insufficient safeguards over the video data. This application also does not address the problems associated with cellular telephone network data delivery.

### SUMMARY OF THE INVENTION

None of the above described background art references teaches or suggests a system and method for a front end for asynchronous video data delivery and display that overcomes the problems associated with cellular telephone network data delivery. Furthermore, none of the above described background art references teaches or suggests such a front end as part of a system and method for asynchronous video data delivery and display that overcomes the problems associated with lack of control over video data once provided to a mobile device.

The present invention, in at least some embodiments, overcomes these drawbacks of the background art by providing a system and method for efficient, asynchronous video data delivery and display, that provides flexibility in terms of the network and technology used for video data delivery, with a front end platform for the mobile device displaying the video data. For example, optionally the mobile device may only download video data when in contact with WiFi or another network technology that does not involve cellular telephone network data delivery. Optionally, delivery through cellular telephone network data systems may be used. Preferably, obtaining video data by the mobile device and granting permission to access thereof is asynchronous with video data display.

The present invention, in at least some embodiments, also provides a system and method for efficient, asynchronous video data delivery and display, that enables the video data owner or originator to control when, how, to whom and for how long the video data can be displayed on the mobile device.

The present invention, in at least some embodiments, also provides a system and method for efficient, asynchronous video data delivery and display, that includes a front end platform which allows developers to build a flexible overlay or “skin”, and yet which maintains control of video delivery and display.

Optionally, the system and method also provides interactive videos for the video clips, for example optionally including a CTA (call to action) functionality that links to and/or launches external content or in-app content. Optionally the content includes but is not limited to an external website, a landing page, a “click to call” to perform an internet call or chat, or a telephone call or chat, an email, another video, an audio file and the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), a thin client, a mobile communication device, a smart watch or other wearable that is able to communicate externally, or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1C show non-limiting, exemplary illustrative system diagrams according to various embodiments of the present invention, while FIGS. 1D-1E show exemplary, non-limiting methods of using same;

FIG. 2A shows a non-limiting, exemplary illustrative system according to various embodiments of the present invention that features a messaging system and FIG. 2B shows an exemplary, non-limiting method of using same;

FIG. 3 shows a diagram of an app and SDK in a non-limiting, exemplary illustrative system according to various embodiments of the present invention;

FIG. 4 shows an exemplary, non-limiting, illustrative flow for registration according to various embodiments of the present invention;

FIGS. 5A and 5B show an exemplary, non-limiting, illustrative method for synchronization of the mobile device with a remote content server according to various embodiments of the present invention;

FIG. 6 shows an exemplary, non-limiting, illustrative method for performing downloads;

FIG. 7 shows an exemplary, non-limiting method for triggering a video playback or broadcast;

FIG. 8 shows an exemplary, non-limiting method for video playback;

FIGS. 9A and 9B show exemplary, non-limiting methods for various interactions of the user with the playback process;

FIG. 10 shows a method exemplary and preferably for playing video fragments; and

FIG. 11 shows an exemplary, non-limiting system 1100 according to at least some embodiments of the present invention.

### DETAILED DESCRIPTION OF SOME EMBODIMENTS

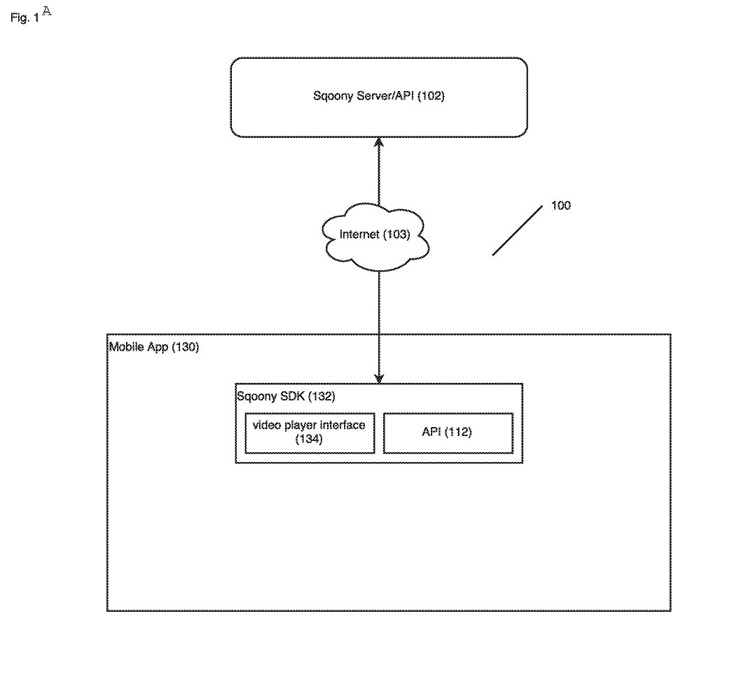

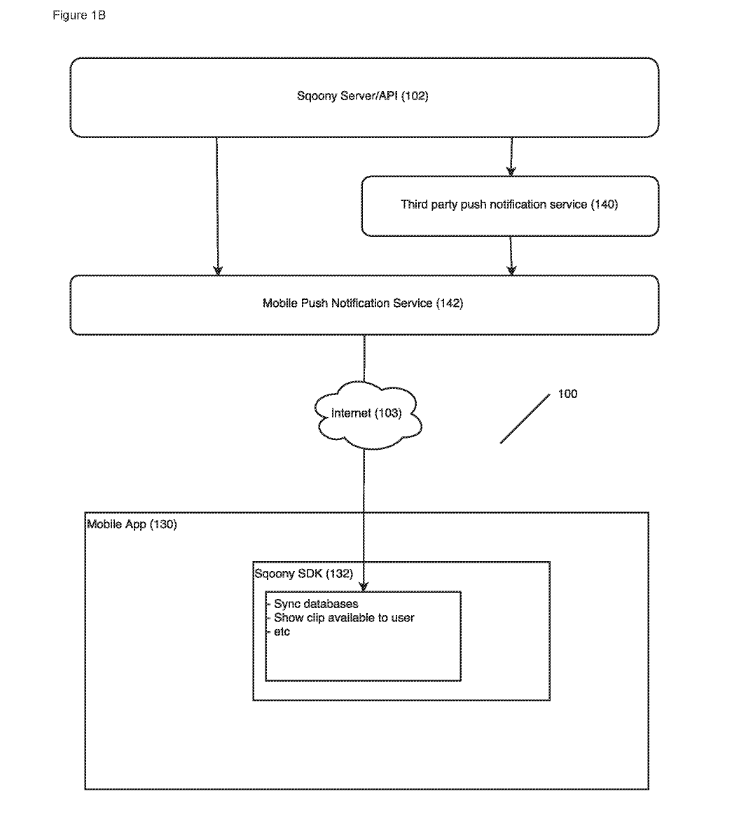

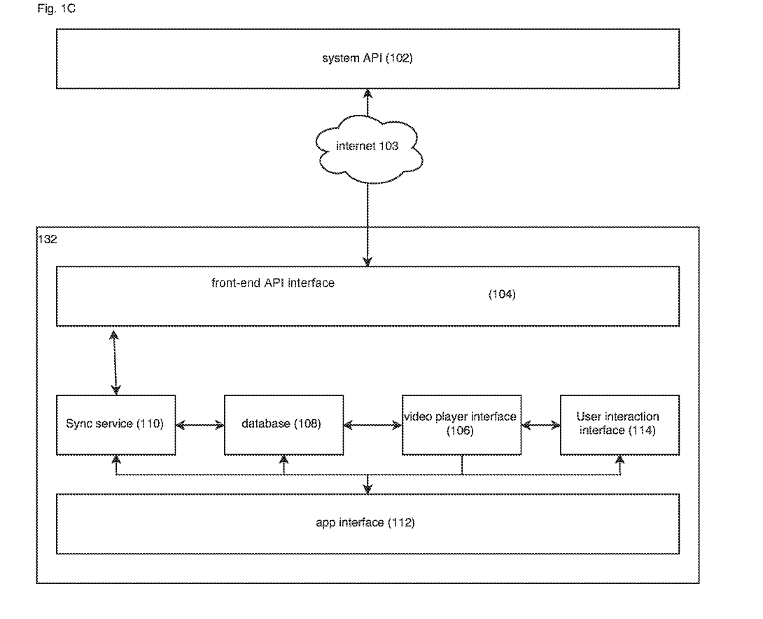

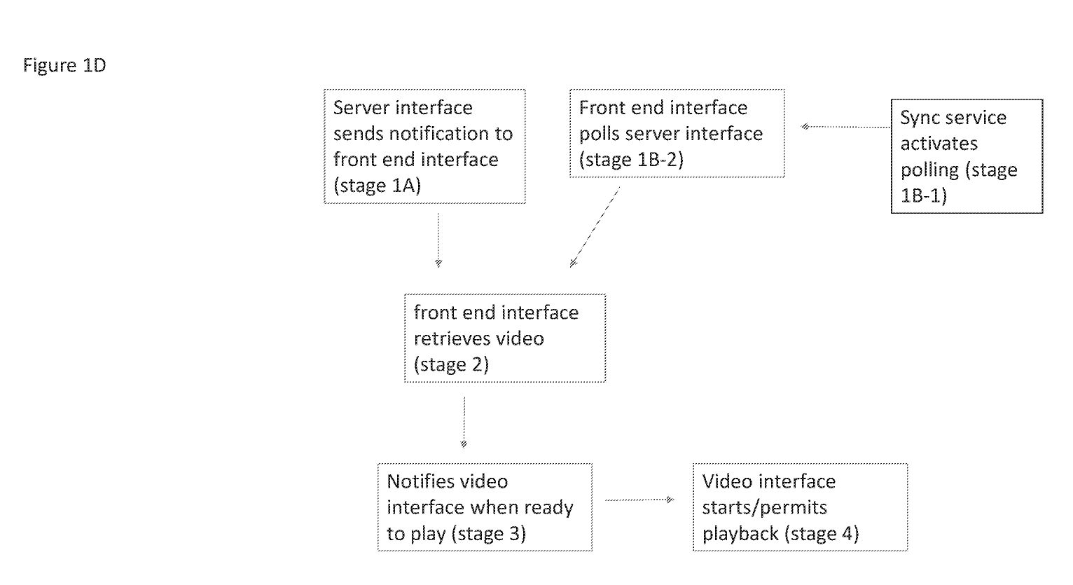

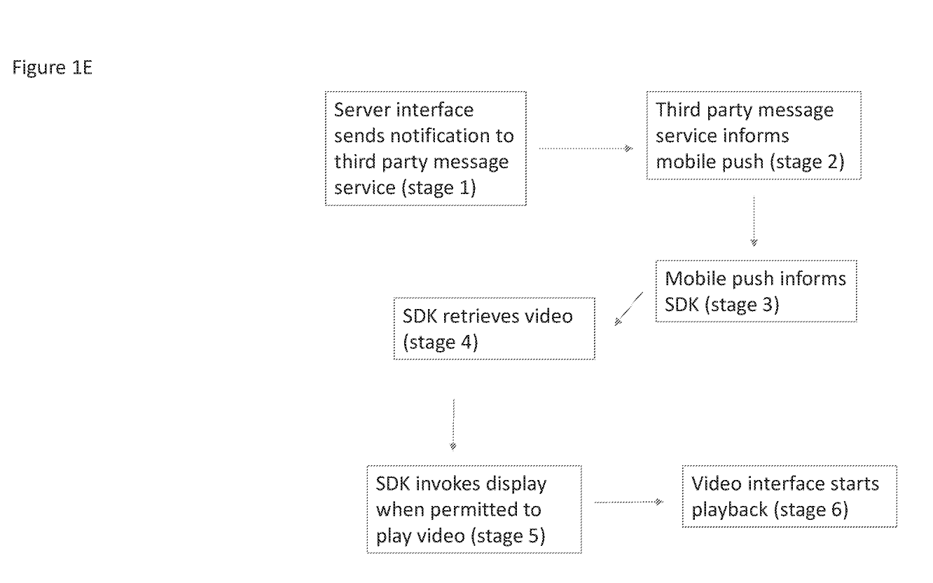

Turning now to the figures, FIG. 1A shows an exemplary non-limiting, illustrative System 100, featuring an API 102 connected to a mobile app 130 through an internet or other computer network connection, 103, as shown. Mobile app 130 option, preferably includes an SDK, which is able to communicate through computer network 103 to API 102. SDK 132 option and preferably includes a video player instance 134 and an API 112.

FIG. 1B shows another illustrative implementation of exemplary System 100, again featuring API 102, computer network connection 103 and mobile app 130. In this case, however, communication is enabled from API 102 through a third-party push notification service 140 to a mobile push notification service 142. Third-party push notification service 140 may optionally comprise the Apple, Google, Amazon or other message notification services. Alternatively, API 102 may optionally communicate directly with mobile push notification service 142.

These push mobile notification services, shown as reference numbers 140 and 142, communicating through computer network 103 to mobile app 130, are able to communicate to SDK 132. In this case, the mobile push notification services, 140 and 142, enable SDK 132 to determine when information is available for download, such as, for example, when a video clip is available for download or when other information is available, which can then be pulled back through the server, through API 102.

FIG. 1C shows another illustrative implementation of System 100. In this case, API 102 communicates to a front-end API interface 104, through computer network 103. Front-end interface 103, in turn, communicates with a sync service 110, with bi-directional communication, so that when videos or other information is available to be downloaded to the app, in this case represented by app interface 112, the information is provided from System API 102 to front-end API interface 104, and in turn, to sync service 110. Sync service 110, in turn, updates a database 108, which includes videos and other information that the user can then access, or the app can access through API interface 112.

Database 108 is updated and, in turn, can interact with video player interface 106, for example, to retrieve a video, when ready for playing. Video player interface 106, in turn, interacts with the user interaction interface 114, which is the interface that handles display. It is preferably overlaid on top of the video player in terms of the user interaction and handles video player back controls as well as processing user input.

FIG. 1D shows an exemplary illustrative method for transmitting notifications and downloading videos between the video server and the front end. In stage 1A the server interface sends a notification to the front end interface. In stage 1B-1, the sync service activates polling, and then stage 1B-2, the front end interface polls the server interface. These two descriptions show two different ways in which a notification is provided or is obtained by the front end interface. In the first case in stage 1A, it is a push notification and the server interface sends that notification to the front end. In the second process for having the front end become informed of a message, the front interface polls the surface interface but is optionally and preferably activated to do so by the sync service, which causes the polling to be made by the front interface.

In stage 2, the front interface retrieves a video. Now this video can be retrieved from the same server which provided the notification a different server. It can be retrieved through a content delivery network. In any case, however, the front interface retrieves the video according to the information provided in the notification, which is either polled or pushed. For example, the notification may include adjacent object which would indicate to the front interface where the video is located that needs to be downloaded and optionally other information such as metadata, and also optionally controller access information such as, for example, when the video could be played.

In stage 3, the front end interface notifies the video interface when the video is ready to be played. This, for example, could optionally and preferably be performed according to special video timing. Perhaps the publisher of the video does not want the video to be played before a certain time, or only wants the video to be played from a certain time to another time, that is during a particular time period. The front interface enables the video interface to know when the video is ready to be played. Of course, optionally a different component at the front end could control the video interface and could notify it when the video is ready to be played.

In stage 4, the video interface either starts playback automatically or alternatively permits playback. For example, the user may need to activate the video interface in order for playback to occur, such that in that example, video playback is not automatic.

FIG. 1E shows an exemplary illustrative non-limiting method for notifications to the front end through a third-party messaging system. As shown, in stage 1 the server interface sends a notification to a third-party message service. Such a third-party message service could optionally be an Apple message service, Google message service, Amazon message service, any message service.

In stage 2, the third-party message service informs the mobile push. The message notification may optionally be executed in two stages (as in this non-limiting example) or in one stage. If executed in two stages, a third party push notification gateway is used in addition to the third-party message service.

In stage 3, the mobile push informs the STK, the is to say the front end interface which is able to receive notifications, is in fact then informed by the mobile push. The notification may optionally include such information as adjacent object, but at least includes information as to where the video can be retrieved from, as well as previously described.

In stage 4, the SDK retrieves the video and brings it down onto the user's personal device which is running the SDK. In stage 5, the SDK invokes the display when it is permitted to play the video. As previously described, there may be timing or other issues which restrict when a video may be played. When the video may be played, then the SDK invokes a display option, preferably a video display, to indicate that now the video can be played.

In stage 6, the video interface starts playback. Again, as previously described, this may optionally be performed automatically as soon as the video interface is informed that playback is possible, or alternatively may optionally be performed after some kind of input from the user, such as user activation of the video interface.

Turning now to FIG. 2A, which shows the System 200, as shown again, System API 102 is featured, communicating through a computer network 103 to front-end API interface 104. In this case, front-end API interface 104 again interacts with app interface 112, but option preferably features additional components, including a notification receiver 200, a notification service 202, a message service 204, and a push handler service 206.

In this case, when an update is available, for example, an updated video, a new video, other information, which the app 130 (not shown) is to download, then preferably a push is made from System API 102, communicating through computer network 103 to message service 204. Message service 204, in turn, indicates that this notification is available, that a message has been received, and is sent to push handler 206. Push handler 206 then provides this information to sync service 110. Message service 204 may optionally not be part of the front-end API 104 and instead may optionally be external to front-end API 104; however, in this case, push handler 206 is preferably contained within front-end API 104.

Upon receiving information about the notification, sync service 110 optionally and preferably communicates to notification receiver 200, which in turn communicates to notification service 202 and hence, to app service 112. Optionally app interface 112 may pull notifications from notification service 202. However, sync service 110 preferably pushes notifications to notification receiver 200. Sync service 110 optionally and preferably then communicates a System API 102 to retrieve the notice, such as, for example, a JSON data object or other information. It may optionally even retrieve the video directly through System API 102.

FIG. 2B is an exemplary non-limiting illustrative method for informing the front end that a video is ready to be retrieved and played. In stage 1, the server interface sends a notification to the third-party message service as previously described.

In stage 2, the third-party message service informs the sync service that a message is ready to be downloaded. The sync service then optionally and preferably performs two functions in stage 3. In stage 3A the sync service informs a notification receiver, and in stage 3B the sync service retrieves the data object or other information regarding the location of the video and optional information such as metadata.

In stage 4, the notification receiver informs a notification service that in fact, a video is ready to be retrieved. This notification optionally and preferably includes information present in the data object which would allow the video to be retrieved. In stage 5, the notification services informs the app interface. In stage 6, the app interface retrieves the data object from the sync service or alternatively may receive the data object directly from the notification service through the notification receiver.

In stage 7, the app interface retrieves the video. Again, the video may optionally be present at one or more different locations, and the app interface preferably retrieves the video and then downloads it as previously described. Subsequent stages, for example, determining when a video is ready for playback and informing the user and/or providing automated playback, may optionally be performed as previously described.

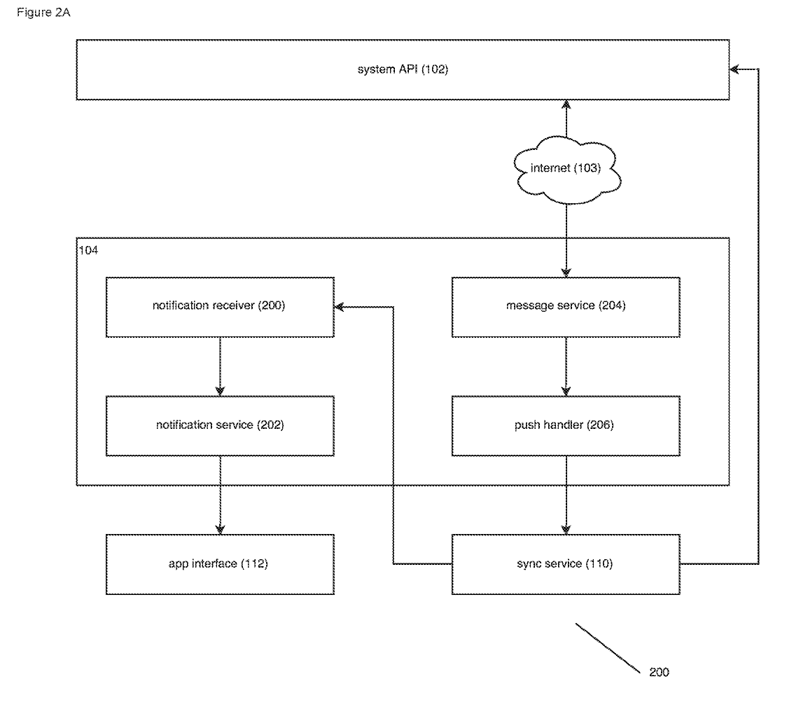

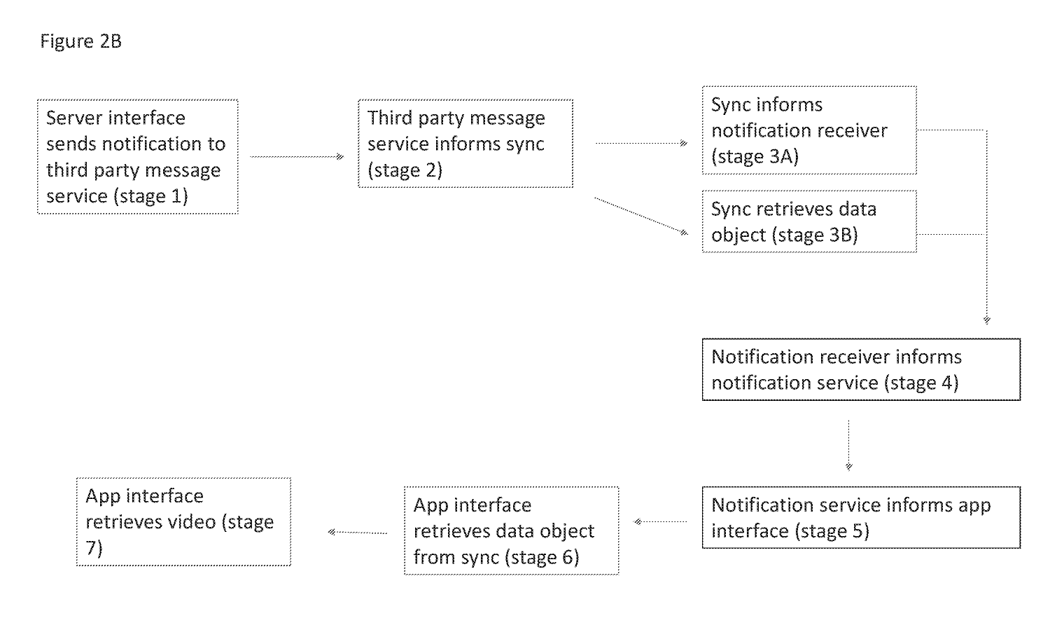

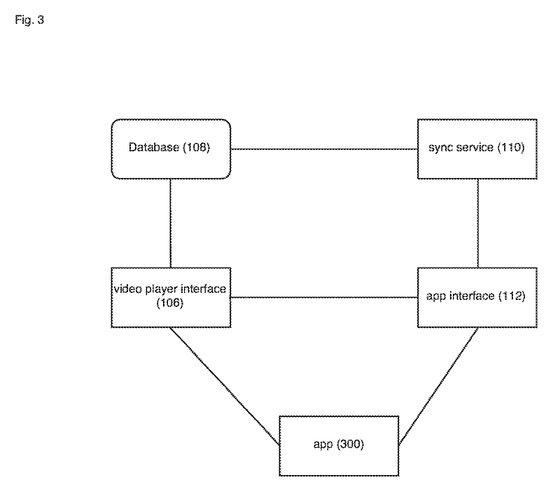

FIG. 3 shows app 300 with an embedded SDK, communicating with video player interface 106 and app interface 112. In this case, the videos are optionally and preferably stored in database 108. The videos can be accessed by video player interface 106. App 300 in this case preferably acts as an overlay to video player interface 106 and includes all of the controls for the user to interact with the video. The interface for app 300 also optionally and preferably provides additional controls and information. In turn, app interface 112 communicates with sync service 110. App interface 112 may also optionally communicate with video player interface 106 to determine which data information is to be downloaded from database 108.

FIG. 4 shows an exemplary flow for registration. In Stage 400, the question is asked as to whether or not the user, or rather, more specifically, a user device operated by a user is registered on the System. If in Stage 401, it is shown that the user device is not registered, then the Stage 401 user device must determine how to register. In Stage 402, Type A registration, the users are registered and have stored data in the app (application) on the user device. Such registration enables the system to keep track of the user device, for example for sending the previously described push notifications. Registering the device also makes it possible to record the app instance for the purpose of the tenant (publisher of content) to optionally manage private subscriptions and other tasks for each subscription.

The registration may optionally be performed by the app on the user device without user intervention by sending information already known (such as for example the e-mail address of the user), by asking the user for all details (such as for example the e-mail address of the user) or by a combination of the two: for example, it could ask the user for its e-mail address, but when registering, also send a unique identifier it already had stored as part of another registration process outside of the scope of this description.

In all cases, the registration information is preferably stored in the local database and the remote content server.

For a Type B registration, as shown in stage 403, the user is asked for information, optionally outside of the scope of interaction with the app. The user supplies information manually. For Type C registration, as shown on 404, Types A and B are combined.

Registration then occurs in Stage 405 and the process ends in Stage 406. Turning back to Stage 400, if it is determined the user is already registered, then the process ends immediately with Stage 406.

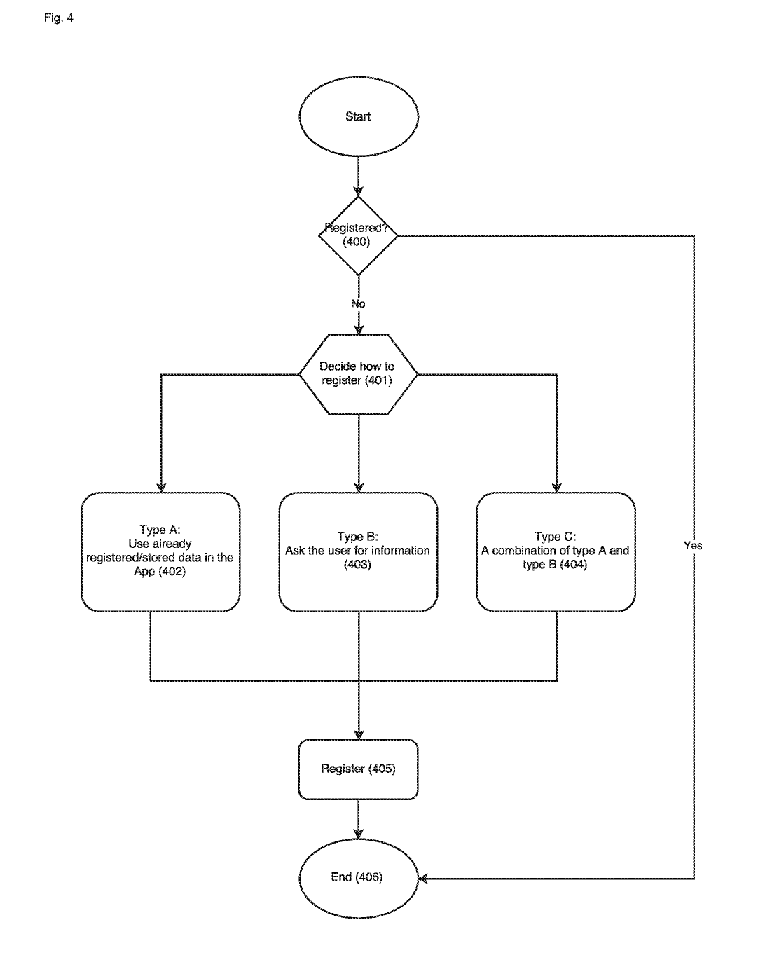

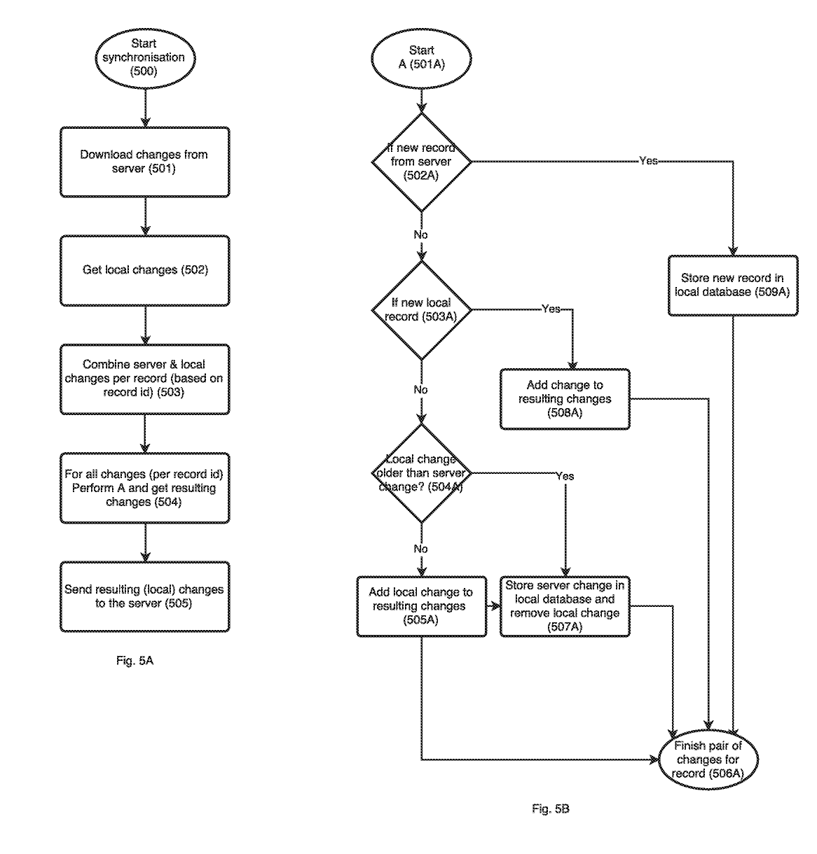

FIG. 5A shows an exemplary, non-limiting, illustrative method for synchronization of the mobile device with a remote content server. In Stage 500, synchronization starts. In Stage 501, changes are downloaded from the server to the mobile device. In Stage 502, local changes are obtained.

Changes can be done locally on the device by the user (subscribing to a channel for example) and remotely on the server (by a tenant (content publisher) subscribing a user device to a channel for example). This process describes how to avoid conflicts when merging these changes. The process in stage 501 relates to the changes done on the server, while the process in stage 502 relates to the changes done locally on the device.

In Stage 503, the server and local changes are combined per record, based on a record ID. The record is a stored entity, for example a subscription, or a channel, or a user's registration details.

For all changes per record ID in Stage 504, the method of FIG. 5B is optionally and preferably performed, and the resulting changes are obtained. The resulting local changes are then sent to the server in Stage 505. FIG. 5B shows the exemplary, illustrative, non-limiting method for process A, referred to in FIG. 5A.

In Stage 501A, process A starts. In Stage 502A it is determined whether a new record is being obtained from the server. If not, then in Stage 503A, it is determined whether a new local record is being obtained. If not, then in Stage 504A, it is asked whether the local changes are older than server changes. In Stage 505A, if not, then the local changes are added to the resulting changes. The process then ends in stage 506A with the local and remote (server) based changes being recorded and stored remotely.

If the local changes are older than the server changes, then in stage 507A the server changes are recorded locally to replace the local changes. The process then ends with the current state of the local and remote (server) based changes being recorded and stored remotely in stage 506A as previously described.

Turning back to stage 503A, if a new local record has been created, then in stage 508A this information is added to any local and server based changes. The process then ends in stage 506A as previously described.

Turning back to stage 502A, if a new server based record has been created, then in stage 509A this information is recorded locally. The process then ends in stage 506A as previously described.

FIG. 6 shows an exemplary, non-limiting, illustrative method for performing downloads. In Stage 600, a new download arrives or in Stage 601, a delayed or aborted download is due. Both of these Stages proceed to Stage 602, when it is determined whether to download. If the download is received, for example, because the mobile device is connected through wireless or according to one or more other parameters, which have been previously set, then in Stage 603, it is determined whether to completely download the video or rather, whether it has been completely downloaded. If so, in Stage 604, it is downloaded and stored or cached.

Going back up to Stage 603, if the video is not downloaded completely, then preferably the meta information is downloaded in Stage 605, along with selected clips. It is then determined in Stage 606 whether to schedule a future download. If not, then in Stage 607, the clips must be streamed, or else they'll be unavailable.

Going back to Stage 602, if a download is not to be performed immediately, then it can be scheduled, as previously described in Stages 606 and 607. The method then proceeds as previously described.

Turning back to Stage 606, if a future download has been scheduled and it's due, then the process continues in Stage 601, as previously described.

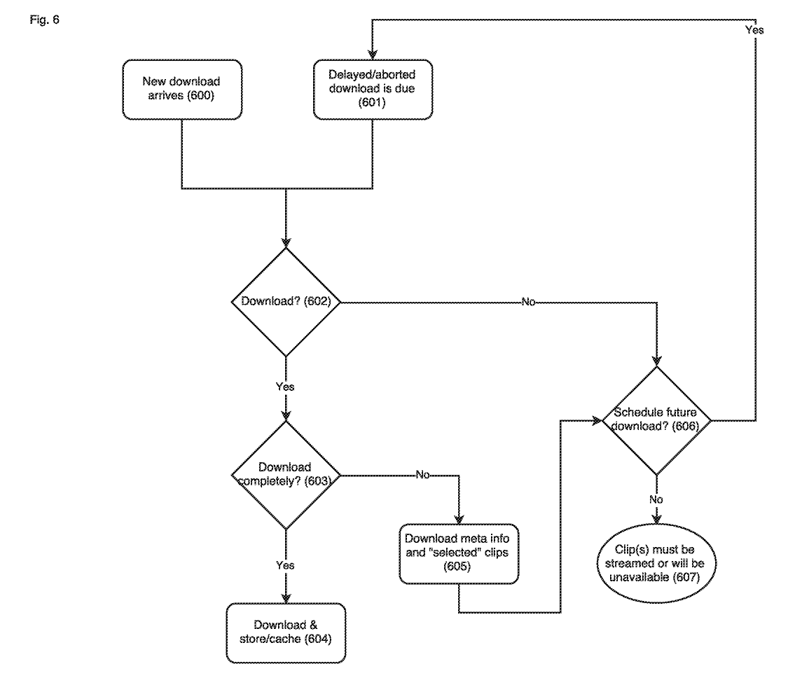

FIG. 7 shows an exemplary, non-limiting method for triggering a video playback or broadcast. Various triggers are first shown. In Stage 700, the date time for video playback arrives. In Stage 701, the user enters a specific locator. In Stage 702, a specific wireless network and/or Bluetooth device is detected.

The triggers are optionally and preferably automatic, by entering a certain geographic location, or if the device picks up a specific wireless network (WiFi or Bluetooth, or iBeacon (which is Bluetooth based). In other words, a trigger can be time based or based upon sensors in the device (for example according to GPS and network hardware being available as sensors).

Stage 703, an iBeacon is triggered, and in Stage 704, any other trigger, external trigger is triggered. It is then determined in Stage 705 whether the user wants a notification as the user may choose to turn it off. In Stage 706, if the user wants a notification, it is determined whether the video should play immediately. If not, then Stage 707, it is determined whether the user is on the recent broadcast screen. If yes, then in Stage 708, the broadcast is highlighted and the process then finishes in Stage 709.

Going back to stage 705, if it turns out that the user wants a notification, then the notification is shown in Stage 711 and the process again finishes in Stage 709.

Going back to Stage 706, if the video is to play immediately, then the video plays in Stage 710 and the process finishes in Stage 709.

Under what circumstances the user wants a notification depends on the device settings, but also the App could decide not to show them immediately, or let the user choose (possibly per channel) whether to immediately show videos, show a notification or only inform in the app (or nothing at all). Location and/or iBeacon notification typically relate to a trigger being specifically based at a specific geographical location.

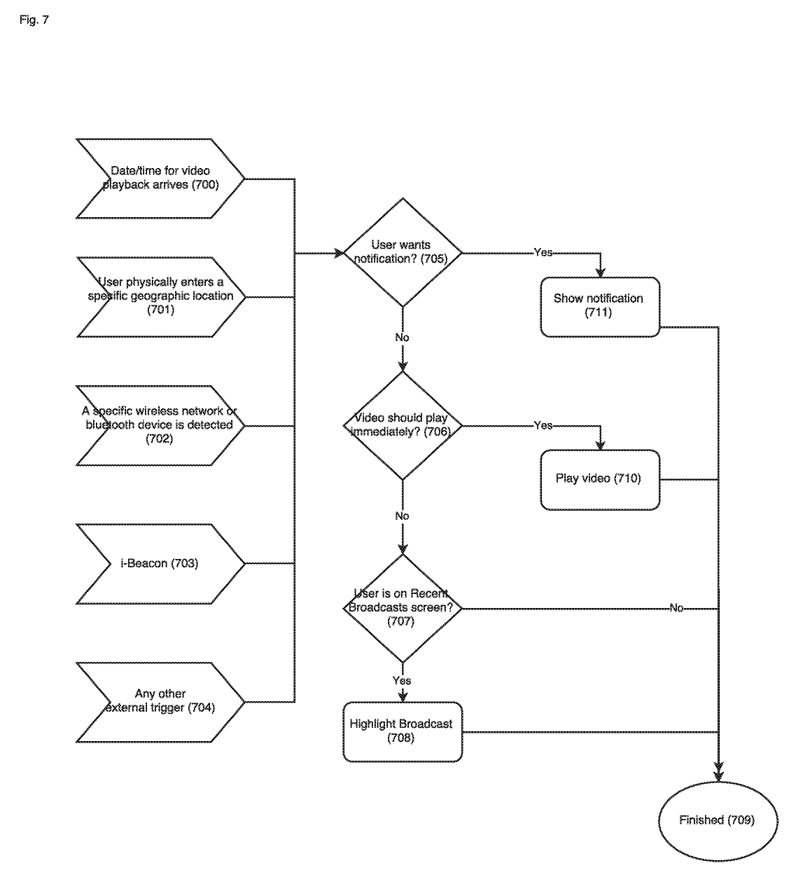

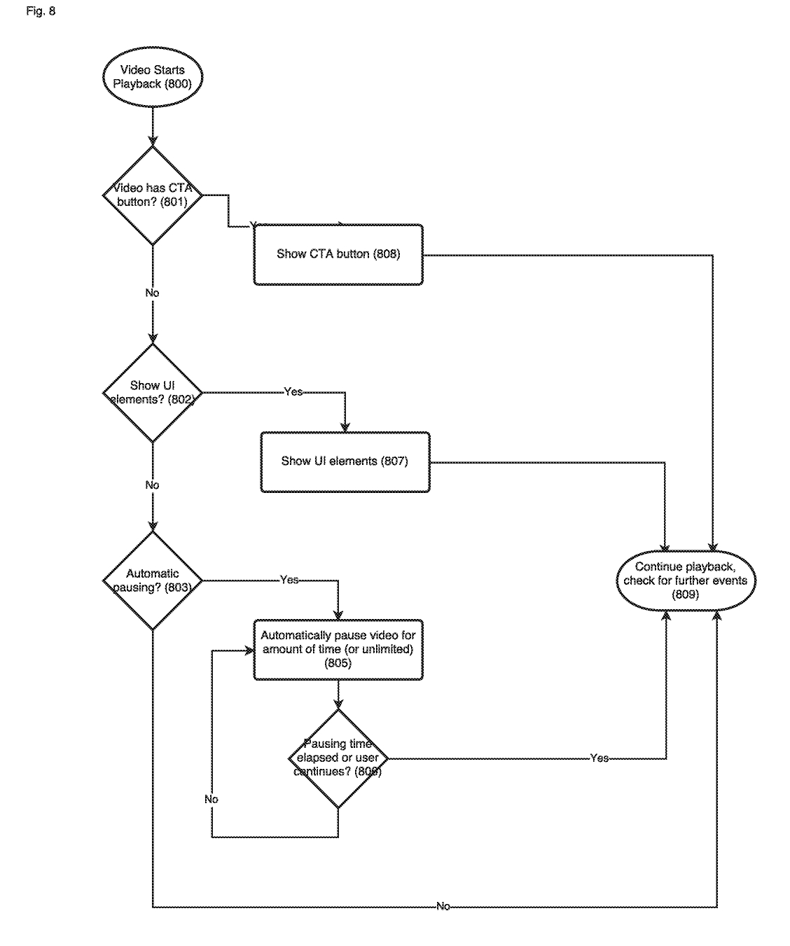

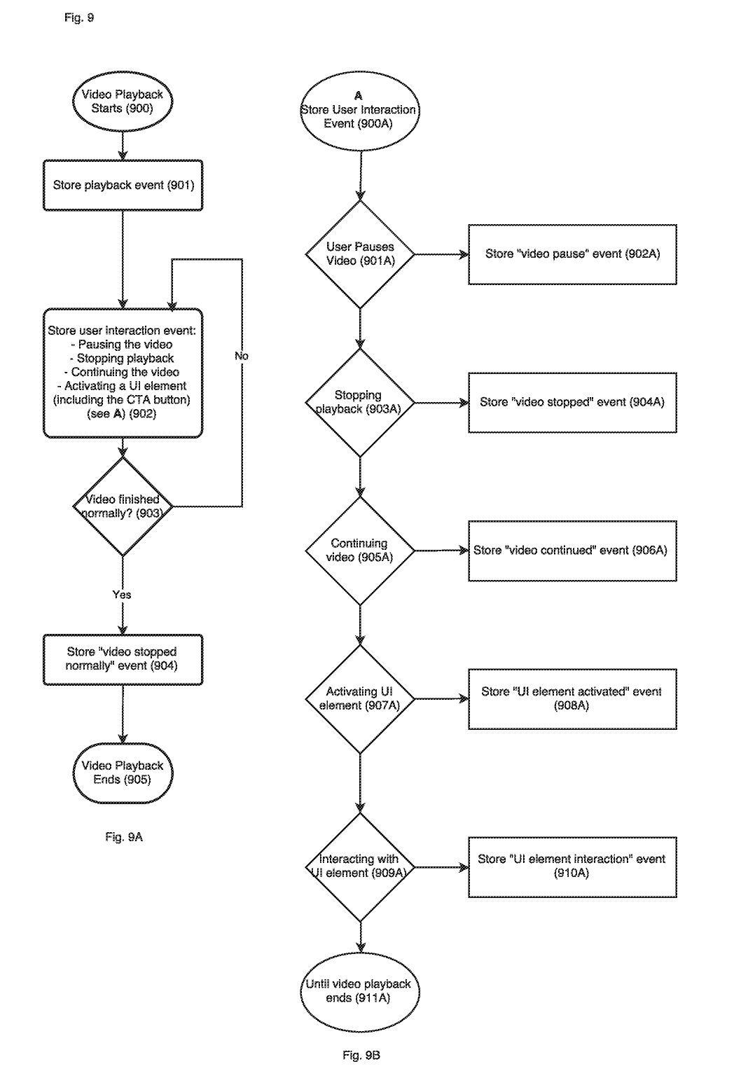

FIG. 8 relates to playback. In Stage 800, the video starts playback. In Stage 801, it is determined whether the video has a CTA button. If not, then in Stage 802, it is determined whether it is time to show the UI elements. If not, then in Stage 803, it is determined whether or not to show automatic pausing. If not, then playback continues and further events are checked in Stage 809.

Automatic pausing may optionally be passed on with the meta-data, as it will be for example possible to automatically pause the video at 10 seconds, pause until the user continues or for a (maximum) of 10 seconds, and again at 20 seconds (with different settings). The meta data can contain information that will automatically pause (and continue) the video during playback at certain points. For example, if the meta data contains a piece of information to pause for 3 seconds at point 5 seconds, when the video is playing and reaches “5 seconds”, it will automatically pause for 3 seconds and then automatically continue.

Turning back now to Stage 803, if it turns out that automatic pausing is permitted, then in Stage 805, it is determined whether to automatically pause the video for a particular amount of time or unlimited. In Stage 806, it is determined whether the pause stops due to lapsed time or because the user indicates that playback continues. If not, the process loops back to Stage 805.

The meta data can contain information to automatically pause the video at certain points, so the text could possibly read “Automatic pausing is triggered by information in the meta data of the video, for example “Pause at a point 15 seconds in the video”.

Video playback is finished when all clips that can play have finished playing, or the user stops playback (not shown).

Continuing with Stage 806, if the permitted amount of time to pause has elapsed or the user wishes for playback to continue, then playback continues as shown in Stage 809. Going back now to Stage 802, if in fact, the UI elements are to be shown, then in Stage 807, they are shown and playback continues in Stage 809, as previously described.

Going back now to Stage 801, if the video has a CTA button, then the CTA button is shown in Stage 808. Optionally and preferably, the CTA will be shown automatically, and there is no reason to have different settings for each part of the clip (pre-roll, post-roll, etc)

The process then continues with playback in Stage 809 and may optionally stop for the previously described reasons.

FIG. 9A relates to various interactions of the user with the playback. Shown in FIG. 9A, in Stage 900, video playback starts. In Stage 901, the playback event is stored. In Stage 902, the stored user interaction event is stored—see FIG. 9A for a detailed description of how the process continues.

In stage 902, if there's some type of user interaction event, the process continues with FIG. 9B. FIG. 9B starts with the stored user interaction event in Stage 900A. In Stage 901A, if the user pauses the video, then the video pause event is stored in Stage 902A. In Stage 903A, if playback is stopped, then the stored video stopped event is stored in-is performed in Stage 904A. If continuing the video in Stage 905A is selected, then the stored video event occurs in Stage 906A. If the UI element is activated by the user in Stage 907A, then store UI element activated event in Stage 908A occurs. The process then drops down to Stage 909A, interacting with the UI element, in which case this interaction is stored in Stage 910A. This repeats until in Stage 911A, the video playback ends.

In stage 903, turning back to FIG. 9A, if the video stopped normally, this event is optionally stored as described with regard to FIG. 9B in stage 904. In stage 905, the video playback stops.

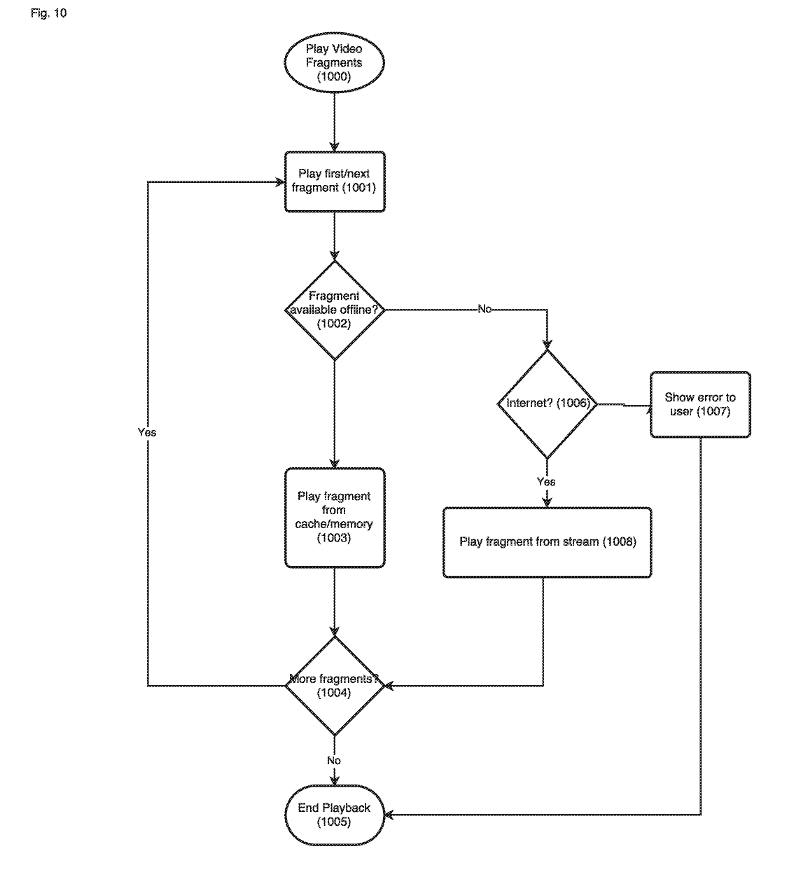

FIG. 10 relates to a method exemplary and preferably for playing video fragments. In Stage 1000, video fragments are played and the process starts. In Stage 1001, the first or next fragment is played. In Stage 1002, it is determined whether the fragment is available offline. If yes, then the fragment is played from the cache or memory in Stage 1004, it is considered whether there are more fragments. If not, the playback ends in Stage 1005. If there are more fragments in Stage 1004, then it returns back to Stage 1001 to look for the next fragment.

Suppose, however, in this case, the fragment is not available offline, in Stage 1002, then in Stage 1006, it is searched for on the internet. If it cannot be found, then in Stage 1007, an error is shown to the user and the playback ends in Stage 1005. If the fragment is found on the internet, in Stage 1006, then the fragment is played from the stream in Stage 1008 and the process continues in Stage 1004 to find out if there are more fragments.

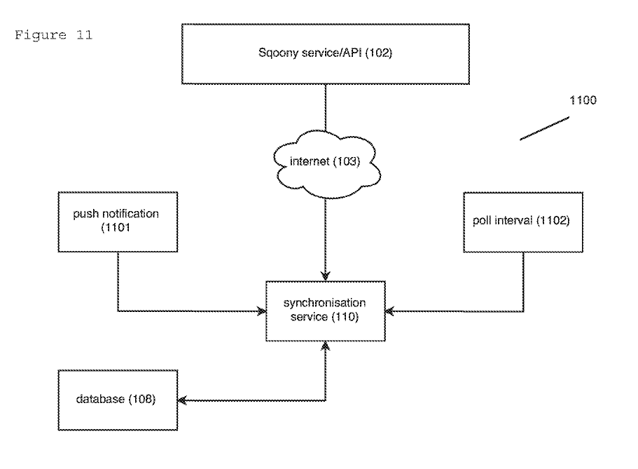

FIG. 11 shows an exemplary, non-limiting system 1100 according to at least some embodiments. Components with the same reference numbers as previous figures have the same or similar function.

System 1100 features additional polling and synchronization components, specifically a push notification 1101 (which may optionally feature a third party push notification service as previously described, but which may not feature such a service) for transmitting push messages to synchronization service 110. Push notification 1101 may optionally receive such message from API 102 (not shown) or alternatively may receive them from a CDN (content delivery network) or from a content publisher. System 1100 also preferably features poll interval 1102 for determining the interval for polling for synchronization service 110, as this embodiment features a combination of push and pull messages. The interval is preferably set according to the last time of communication with API 102 and optionally also according to one of the following parameters: type of network that the user device (mobile device) is connected to, whether for cellular data or WiFi data for example; the amount of data transferred over the last period; the last time of a push notification message and/or polling action; and/or according to a call back to the app on the user device, which may optionally block or force user synchronization. The data to synchronize optionally includes user and/or registration information, information about channel subscriptions, information about broadcasts and/or clips, and/or user statistics.

In terms of synchronization of data, poll frequency is optionally based on: app configuration (with defaults, App can ask user if required); the type of network type and quality (3G, 4G, specific WiFi, general WiFi, etc.); when the last time information was received from the system server (either through a push notification or a poll action); how much data has already been transferred during a specified period; whether the call-back to the App vetoes the poll request; whether the app is running in the foreground or in the background; and/or any limitations the mobile platform (user device) has on data access, or a combination thereof.

In terms of selected data that is synchronized, optionally and preferably the following are included; user registration information; channels; broadcasts; clips; CTA (call-to-action) User Interaction data, including clip viewing statistics. Data is synchronized both ways, whereby the Server acts as a gateway when multiple devices for the same user are active. Conflicts are resolved by always using the latest change, including any changes in subscriber-info, channels, subscriptions, broadcasts, clips and user-interaction which are stored in a local database (for both online and offline usage).

In terms of notifications, the Server can optionally push notifications through a third party and/or the mobile platform's push notification service. Each push notification contains information about changes in data (i.e. it notifies the synchronisation service). If the notification is about a new broadcast, an attempt is made to download the video.

Videos and associated metadata, CTAs and so forth are optionally and preferably stored in database 108. Storage management is optionally performed as follows. Videos are deleted based on metadata transmitted with the video which decide when (a combination of conditions can be AND or OR): a certain time after downloading has passed; the video is viewed an X amount of times; after a certain date/time; or based on the availability of cached storage, for example when a new video comes in and the amount of videos is above X (a combination of App selection and/or user selection); when a new video comes in and the amount of storage space used is above Y (for example, in MB, as a combination of App selection and/or user selection); and/or the older videos not marked as favourite and already watched are selected to be deleted.

While the invention has been described with respect to a limited number of embodiments, it will be appreciated that many variations, modifications and other applications of the invention may be made, including different combinations of various embodiments and sub-embodiments, even if not specifically described herein.

What is claimed is:

1. A system for efficient, asynchronous video data delivery, comprising a front-end platform, an app, a mobile device for operating said front-end platform and said app, and a video delivery platform, wherein said video delivery platform notifies said front-end platform of availability of a video clip according to a notification message and wherein said front-end platform pulls said video clip from said video delivery platform according to said notification message when said mobile device is connected to a network technology that does not involve cellular telephone network data delivery, and wherein said app has access to said video according to at least one control by said front-end platform.

2. The system of claim 1, wherein said network technology comprises WiFi.

3. The system of claim 2, wherein said video delivery platform sets display parameters for display of said video and transmits said display parameters to said front-end platform; wherein access by said app to said video is controlled according to said display parameters by said front-end platform.

4. The system of claim 3, wherein said display parameters relate to one or more of when, how, to whom and for how long the video clip can be displayed on the mobile device.

5. The system of claim 4, wherein said front-end platform receives a message from said video platform when the video clip is ready and wherein said front-end platform pulls the video clip according to said message.

6. The system of claim 1, further comprising providing an interactive video for said video clip.

7. The system of claim 6, further comprising a CTA (call to action) functionality that links to and/or launches external content or in-app content.

8. The system of claim 7, wherein said content comprises an external website, a landing page, a “click to call” to perform an internet call or chat, or a telephone call or chat, an email, another video, an audio file and the like.

9. The system of claim 8, wherein said CTA functionality is provided through pre-roll or post-roll.

10. The system of claim 1, further comprising detecting user behavior in regard to interacting with the video clip by front-end platform and transmission of said information for analysis by said video platform.

11. The system of claim 1, wherein the front-end platform comprises a sync service for polling the video server for a notification of a video available for download.

12. The system of claim 1, further comprising a third party messaging service for pushing a notification of a video available for download to the front-end platform.

13. The system of claim 12, wherein the front-end platform downloads the video in response to said notification.
